(19) United States
(12) Patent Application Publication
(10) Pub. No.: US 2012/0194529 A1
(43) Pub. Date: Aug. 2, 2012

(54) INTERFACE CARD

(75) Inventor: Yu-Lin LIU, New Taipei City (TW)

(73) Assignee: MICRO-STAR INT'L CO., LTD., New Taipei City (TW)

(21) Appl. No.: 13/167,227

(22) Filed: Jun. 23, 2011

(30) Foreign Application Priority Data
Feb. 1, 2011 (TW) 100202451

(51) Int. Cl. G06F 13/14

(52) U.S. Cl. 345/520

(57) ABSTRACT

An interface card comprising a graphic unit, an outputting interface, an inputting interface, an assigning processor and a card body is disclosed. The inputting interface is used for receiving a PCIE inputting signal. When the inputting interface is electrically connected to a CPU via a connector, the PCIE inputting signal is inputted to the assigning processor via an inputting interface. The assigning processor assigns a PCIE outputting signal to a graphic unit according to the PCIE inputting signal, and further assigns another PCIE outputting signal to another graphic unit according to the PCIE inputting signal when the outputting interface is externally connected to another graphic unit. The card body is used for placing the graphic unit, the outputting interface, the assigning processor and the inputting interface.

This application claims the benefit of Taiwan application Serial No. 100202451, filed Feb. 1, 2011, the subject matter of which is incorporated herein by reference.

### BACKGROUND OF THE INVENTION

1. Field of the Invention

The invention relates in general to an interface card, and more particularly to an interface card with an assigning processor.

2. Description of the Related Art

Referring to FIG. 1, a schematic diagram of a first conventional notebook computer is shown. The conventional notebook computer 1 comprises a CPU 11, an assigning processor 12, a graphic unit 13, a graphic unit 14 and a motherboard 15. The CPU 11, the assigning processor 12, the graphic unit 13 and the graphic unit 14 are disposed on the motherboard 15. The assigning processor 12 is realized by such as a Lucid chip or PLX chip. The assigning processor 12, according to a PCIE inputting signal 51 outputted from the CPU 11, assigns a PCIE outputting signal S2 and a PCIE outputting signal S3 to the graphic unit 13 and the graphic unit 14 respectively. The graphic unit 13 and the graphic unit 14 are realized by such as a graphic processing unit (GPU) or a mobile PCIE express module (MXM).

The mobile PCIE express module is a graphic module protocol for nVIDIA using PCI-E. The mobile PCIE express module is mainly used in the mobile platform of a notebook computer. The graphic unit of the products using the said protocol is not directly soldered on the motherboard and is like the independent display card slot of a desktop computer, so that the user is allowed to replace the display card for the convenience of service and repair.

Referring to FIG. 2, a schematic diagram of a second conventional notebook computer is shown. The conventional notebook computer 2 comprises a CPU 11, an assigning processor 12, a graphic unit 13 and a motherboard 25. The CPU 11, the assigning processor 12 and the graphic unit 13 are disposed on the motherboard 25. The conventional notebook computer 2 can be externally connected to a signal expansion unit 26 realized by such as a signal expansion docking or a signal expansion box. The signal expansion unit 26 can further comprise a graphic unit 14. The assigning processor 12 assigns a PCIE outputting signal S2 and a PCIE outputting signal S3 to the graphic unit 13 and the graphic unit 14 respectively according to a PCIE inputting signal S1 outputted from the CPU 11.

The assigning processor 12 is disposed on the motherboard 15 or 25 for both the conventional notebook computers 1 and 2, no only increasing the cost of motherboard parts but also consuming more power.

### SUMMARY OF THE INVENTION

The invention is directed to an interface card with an assigning processor. The assigning processor is disposed on the interface card not a motherboard, hence reducing the cost of motherboard parts and saving power consumption.

According to an aspect of the present invention, an interface card is disclosed. The interface card comprises a graphic unit, an outputting interface, an inputting interface, an assigning processor and a card body. The inputting interface is used for receiving a PCIE inputting signal. When the inputting interface is electrically connected to a CPU via a connector, the PCIE inputting signal is inputted to the assigning processor via an inputting interface. The assigning processor assigns a PCIE outputting signal to a graphic unit according to the PCIE inputting signal, and further assigns another PCIE outputting signal to another graphic unit according to the PCIE inputting signal when the outputting interface is externally connected to another graphic unit. The card body is used for placing the graphic unit, the outputting interface, the assigning processor and the inputting interface.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a schematic diagram of a first conventional notebook computer;

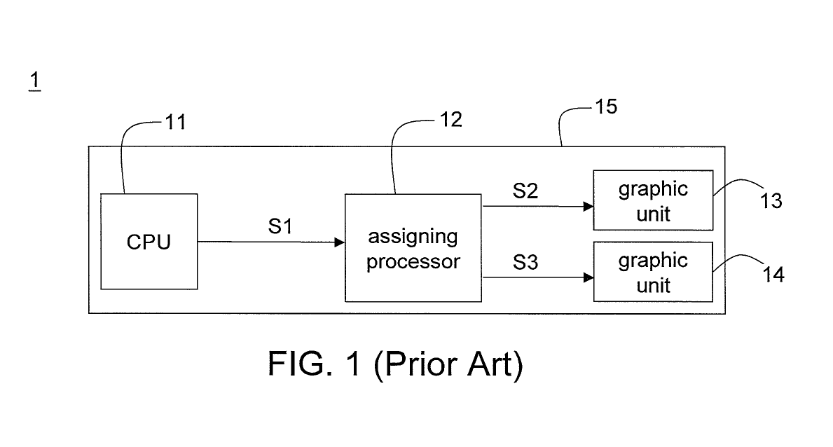

FIG. 2 shows a schematic diagram of a second conventional notebook computer;

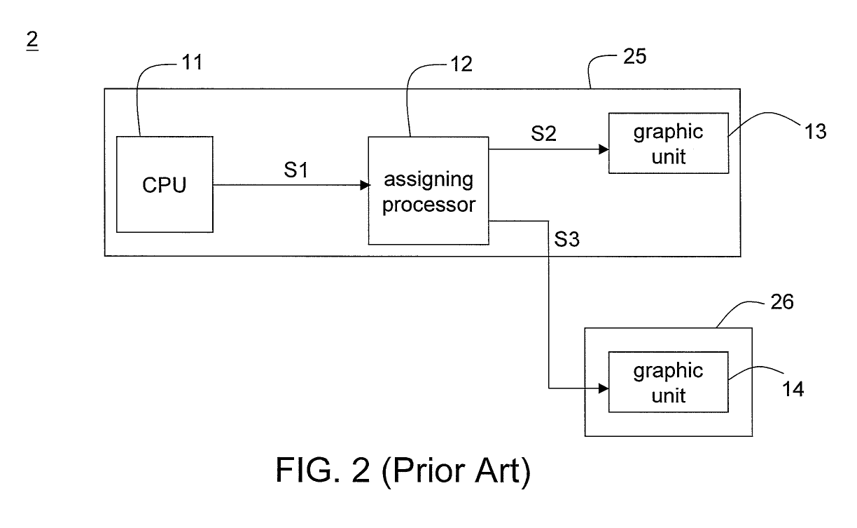

FIG. 3 shows a schematic diagram of an interface card according to a first embodiment of the invention;

FIG. 4 shows a schematic diagram of an interface card according to a second embodiment of the invention;

FIG. 5 shows a schematic diagram of an interface card according to a third embodiment of the invention.

### DETAILED DESCRIPTION OF THE INVENTION

To decrease the cost of motherboard parts and reduce the power consumption, a variety of interface card are disclosed in the embodiments below. The interface card at least comprises a graphic unit, an outputting interface, an inputting interface, an assigning processor and a card body. The inputting interface is used for receiving a PCIE inputting signal. When the inputting interface is electrically connected to a CPU via a connector, the PCIE inputting signal is inputted to the assigning processor via an inputting interface. The assigning processor assigns a PCIE outputting signal to a graphic unit according to the PCIE inputting signal, and further assigns another PCIE outputting signal to another graphic unit according to the PCIE inputting signal when the outputting interface is externally connected to another graphic unit. The card body is used for placing the graphic unit, the outputting interface, the assigning processor and the inputting interface.

### First Embodiment

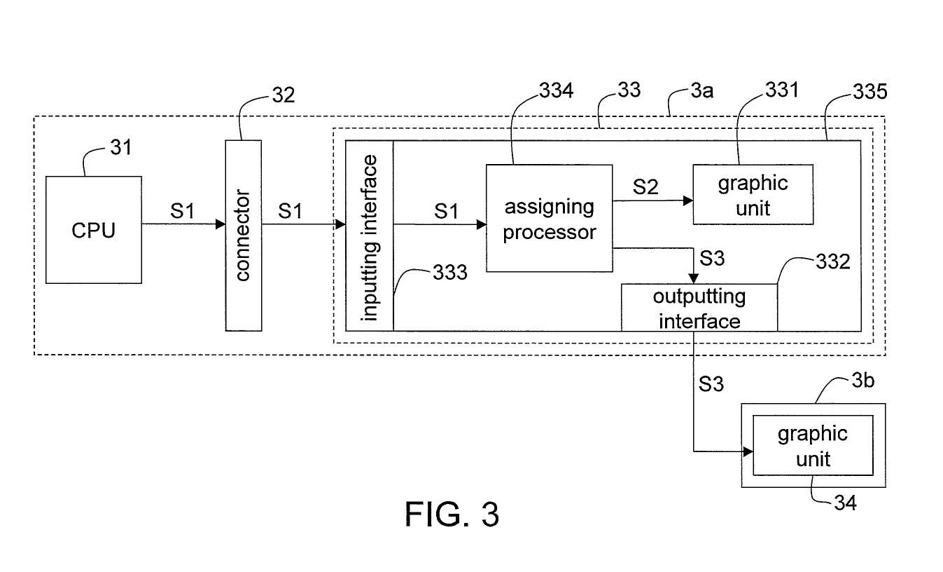

Referring to FIG. 3, a schematic diagram of an interface card according to a first embodiment of the invention is shown. The computer 3a is realized by such as notebook computer. The computer 3a comprises a CPU 31, a connector 32 and an interface card 33. The connector 32, used for electrically connecting the CPU 31 to the interface card 33, is realized by such as a mobile PCIE express module (MXM) connector. The interface card 33 is realized by such as a mobile PCIE express module (MXM) card or a PCIE transfer card.

The interface card 33 comprises a graphic unit 331, the outputting interface 332, the inputting interface 333, the assigning processor 334 and the card body 335. The graphic unit 331 is realized by such as graphic processing unit (GPU). The outputting interface is realized by such as PCIE the connector. The inputting interface 333, realized by such as a plug end also known as the golden finger, is electrically connected to a CPU 31 via a connector 32. The assigning processor 334, realized by such as Lucid chip or PLX chip, is electrically connected to the graphic unit 331, the outputting interface 332 and the inputting interface 333. The graphic unit 331, the outputting interface 332, the inputting interface 333 and the assigning processor 334 is disposed on the card body 335.

The outputting interface is used for electrically connecting the graphic unit 34 such as disposed on a signal expansion unit 3b. The signal expansion unit 3b is realized by such as a signal expansion docking or a signal expansion box. For convenience of elaboration, the signal expansion unit 3b of FIG. 3 has one graphic unit. However, the invention is not limited thereto, and the number of the graphic unit disposed on the signal expansion unit 3b can be adjusted to fit actual needs.

The inputting interface 333 is used for receiving a PCIE inputting signal S1. When the inputting interface 333 is electrically connected to the CPU 31 via the connector 32, the PCIE inputting signal S1 is inputted to the assigning processor 334 via the inputting interface 333. The assigning processor 334 assigns the PCIE outputting signal S2 to the graphic unit 331, the assigning processor 334 according to the PCIE inputting signal S1, and assigns the PCIE outputting signal S3 to the graphic unit 34 according to the PCIE inputting signal S1 when the outputting interface 332 is externally connected to the graphic unit 34. The graphic unit 34 is realized by such as a processing unit (GPU) or a mobile PCIE express module (MXM).

The assigning processor 334 is disposed on the interface card 33 not on a motherboard, hence reducing the cost of motherboard parts and saving power consumption. Also, by externally connecting the interface card 33 to the graphic unit 34, an effect of double upgrade will be achieved and the graphics performance of the computer 3a will be improved. For example, if the interface card 33 is realized by a mobile PCIE express module card, then an effect of double upgrade will be achieved by externally connecting the outputting interface 332 to a display card.

### Second Embodiment

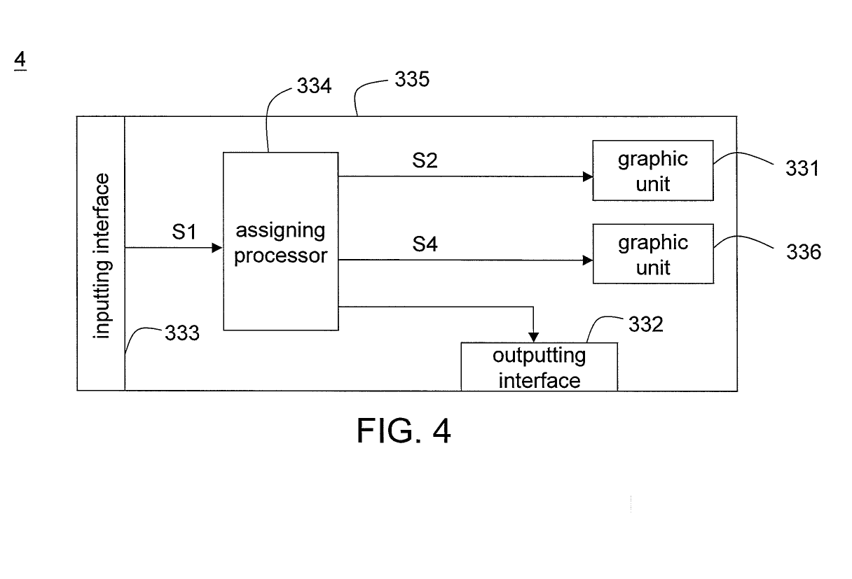

Referring to FIG. 4, a schematic diagram of an interface card according to a second embodiment of the invention is shown. The interface card 4 of the present embodiment is different from the interface card 33 of the first embodiment in that the interface card 4 further comprises a graphic unit 336 realized by such as a graphic processing unit (GPU). The graphic unit 336 is disposed on the card body 335. The assigning processor 334 assigns the PCIE outputting signal S4 to the graphic unit 336 according to the PCIE inputting signal S1. The graphics performance of the interface card 4 can further be improved through the graphic unit 336. For convenience of elaboration, the interface card 4 of FIG. 4 has two graphic units. However, the invention is not limited thereto, and the number of the graphic unit disposed on the interface card 4 can be adjusted to fit actual needs.

### Third Embodiment

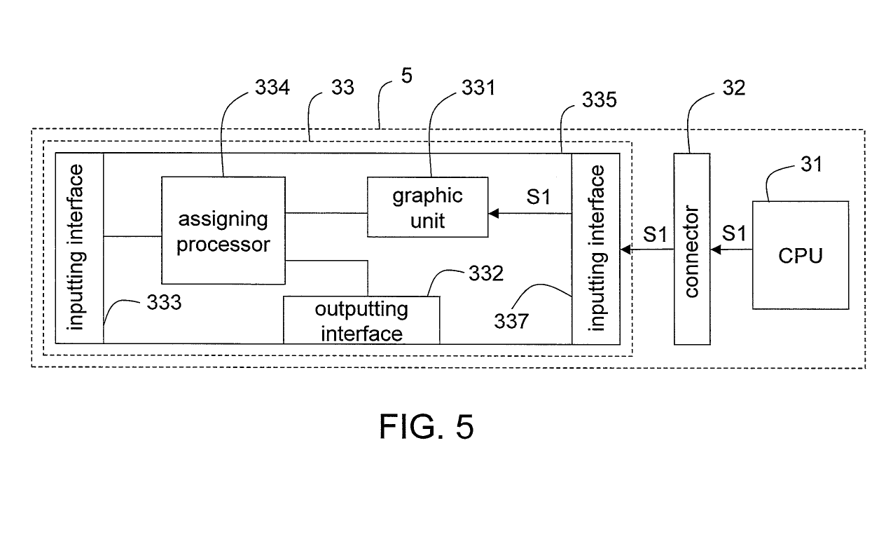

Referring to FIG. 5, a schematic diagram of an interface card according to a third embodiment of the invention is shown. The interface card 5 of the present embodiment is different from the interface card 33 of the first embodiment mainly in that the interface card 5 further comprises an inputting interface 335 realized by such as a plug end also known as the golden finger and electrically connected to the CPU 31 via the connector 32. The inputting interface 333 and the inputting interface 335 are respectively disposed on the two sides of the card body 335. The interface card 5 can be electrically connected to the connector 32 via the inputting interface 333 or the inputting interface 335 selectively.

When the outputting interface 332 is externally connected to the graphic unit 34, the interface card 5 can be electrically connected the connector 32 via the inputting interface 333 as indicated in FIG. 3 for receiving a PCIE signal S1 from the CPU 31. To the contrary, if the outputting interface 332 is not externally connected to the graphic unit 34, the interface card 5 can be electrically connected to the connector 32 via the inputting interface 335 for receiving a PCIE signal S1 from the CPU 31. Since the assigning processor 334 does not need to assign the PCIE signal, the interface card 5 further turns off the power supply of the assigning processor 334 to reduce power consumption.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An interface card, comprising:
a first graphic unit;
an outputting interface;
a first inputting interface used for receiving a PCIE inputting signal;
an assigning processor, wherein the PCIE inputting signal is inputted to the assigning processor via the first inputting interface when the first inputting interface is electrically connected to a CPU via a connector, and the assigning processor assigns a first PCIE outputting signal to the first graphic unit according to the PCIE inputting signal and further assigns a second PCIE outputting signal to the second graphic unit according to the PCIE inputting signal when the outputting interface is externally connected to a second graphic unit; and
a card body used for placing the first graphic unit, the outputting interface, the assigning processor and the first inputting interface.

2. The interface card according to claim 1, further comprising:
a third graphic unit disposed on the card body, wherein the assigning processor I assigns a third PCIE outputting signal to the third graphic unit according to the PCIE inputting signa.

3. The interface card according to claim 1, further comprising:
a second inputting interface disposed on the card body, wherein the PCIE inputting signal is inputted to the first graphic unit via the second inputting interface when the second inputting interface is electrically connected to the first graphic unit via a connector.

4. The interface card according to claim 3, wherein the first inputting interface and the second inputting interface are respectively disposed on two sides of the card body.

5. The interface card according to claim 1, wherein the interface card is a mobile PCIE express module (MXM) card.

6. The interface card according to claim 1, wherein the interface card is a PCIE transfer card.

7. The interface card according to claim 1, wherein the second graphic unit is a mobile PCIE express module (MXM).

8. The interface card according to claim 1, wherein the second graphic unit is a graphic processing unit (GPU).
